(19) United States
(12) Patent Application Publication
(10) Pub. No.: US 2017/0210104 A1
(43) Pub. Date: Jul. 27, 2017

(54) TRANSPARENT PLASTIC SHEET

(71) Applicant: KOLON INDUSTRIES, INC., Gwacheon-si, Gyeonggi-do (KR)

(72) Inventors: Jun Kil DOO, Yongin-si (KR); Sang Hwa SHIM, Yongin-si (KR); Chun Sung CHO, Yongin-si (KR)

(73) Assignee: KOLON INDUSTRIES, INC., Gwacheon-si, Gyeonggi-do (KR)

(21) Appl. No.: 15/514,849

(22) PCT Filed: Sep. 30, 2015
(86) PCT No.: PCT/KR2015/010303

§ 371 Date: Mar. 28, 2017

(30) Foreign Application Priority Data
Sep. 30, 2014 (KR) 10-2014-0131443
Sep. 30, 2015 (KR) 10-2015-0137343

(51) Int. Cl. B32B 27/08; B32B 27/36; B32B 7/02; B32B 27/30

(52) U.S. Cl. CPC B32B 27/08; B32B 27/30; B32B 27/36; B32B 7/02

(57) ABSTRACT

This invention relates to a transparent plastic sheet including a support layer composed of a polycarbonate-based resin layer and a surface layer formed on the support layer and composed of a polymethylmethacrylate-based resin layer having a glass transition temperature of 120 to 135° C., wherein the polymethylmethacrylate-based resin layer has a thickness corresponding to 5 to 20% of a total thickness of the sheet, and the sheet has a total transmittance of 89 to 94% based on ASTM D1003, whereby the transparent plastic sheet can be minimally deformed under high-temperature and high-humidity conditions and can thus be usefully applied as a window cover for various display products, in lieu of glass.

### TECHNICAL FIELD

The present invention relates to a transparent plastic sheet, and more particularly to a plastic sheet having a multilayer structure, which is useful as a cover sheet for the protection of the front surface of a display.

### BACKGROUND ART

A glass material has been mainly used as a conventional display material for electrode substrates for liquid crystal display panels, plasma display panels, electroluminescent fluorescent display tubes, or light-emitting diodes. However, glass breaks easily and has high specific gravity, and is of limited usefulness in realizing slimness and lightweightness and is thus unsuitable for use in a flexible display. Hence, a transparent plastic material serving as a replacement for glass material is receiving attention. A plastic material is lightweight, is difficult to break, and enables the reduction of the manufacturing cost, and is thus expected to exhibit high competitiveness in conventional fields using glass.

In particular, a variety of display devices such as LCDs, PDPs, mobile phones, or projection TVs have been developed, and thus many attempts are being made to manufacture a protective cover sheet, namely a window sheet, which is located at the outermost position of such a display device, using a plastic material. The plastic material, which is used in lieu of glass, is exemplified by a polycarbonate (PC) resin. PC is superior in transparency, impact resistance, heat resistance, freedom of processing, and lightweightness, and is utilized not only in meter covers or liquid crystal display covers for electric and electronic devices, but also in cars including window glass, sunroof, and instrument covers, and building materials such as lighting and roofing materials or windowpanes.

With regard to conventional window sheets using a plastic material, provided is a transparent resin sheet suitable for use in a liquid crystal display cover, comprising a UV coating layer on one surface thereof and a phase-difference film on the other surface thereof (Japanese Patent Application Publication No. 2000-321993), or a method of manufacturing a polycarbonate resin laminate through coating with a cured coating layer having superior impact resistance (Japanese Patent Application Publication No. 2004-130540). Furthermore, there is disclosed a material imparted with high transparency, high surface hardness, weather resistance, chemical resistance, durability or heat resistance by coating the surface of a transparent plastic film with a high-hardness material including a silsesquioxane resin having photocurability and then curing it with light (Japanese Patent Application Publication No. 2008-037101).

However, as various instruments and devices are manufactured to be small and lightweight and to have high performance and low price, use conditions of the resin molded products including liquid crystal display covers are becoming more stringent. Simultaneously, in order to cope with low price and small quantity batch production, a resin material having high productivity is strongly required. Hence, PC, which is widely useful as a glass replacement plastic, is limited in surface properties such as low surface hardness and low reflectivity, and thus there are many constraints inhibiting expansion to the supply stage. Accordingly, thorough research is ongoing into improving the transparency, surface hardness, durability and heat resistance of plastic material.

In the research and development trends so far, a plastic sheet that exhibits the most stable properties is known to be a sheet configured such that PC and PMMA are stacked. The sheet configured such that PC and PMMA are stacked is regarded as somewhat successfully achieving transparency, surface hardness, durability and heat resistance, but high deformation under high-temperature and high-humidity conditions, low light resistance and surface properties still remain a challenge.

### DISCLOSURE

### Technical Problem

Accordingly, the present invention is intended to provide a transparent plastic sheet having a multilayer structure, which may be minimally deformed under high-temperature and high-humidity conditions.

### Technical Solution

A preferred embodiment of the present invention provides a transparent plastic sheet, comprising a support layer including a polycarbonate-based resin layer, and a surface layer formed on the support layer and composed of a polymethylmethacrylate-based resin layer having a glass transition temperature of 120 to 135° C., wherein the polymethylmethacrylate-based resin layer has a thickness corresponding to 5 to 20% of a total thickness of the sheet, and the sheet has a total transmittance of 89 to 94% based on ASTM D1003.

In the above embodiment, the support layer may have a monolayer structure, comprising a polycarbonate-based resin layer, or a multilayer structure, comprising two polycarbonate-based resin layers and a polymethylmethacrylate-based resin layer having a glass transition temperature of 120 to 135° C. disposed between the two polycarbonate-based resin layers, and the polymethylmethacrylate-based resin layer disposed between the two polycarbonate-based resin layers may have a thickness corresponding to 5 to 20% of the total thickness of the sheet.

Here, the transparent plastic sheet may have a water absorption of 0.15 to 0.2% at a temperature of 35° C. and a relative humidity of 97% and a dimensional change of 0.2 to 0.25% at a temperature of 65° C. and a relative humidity of 90%.

In the above embodiment, the transparent plastic sheet may have a pencil hardness of H to 2H based on ASTM D3363, which is a surface hardness of the surface of the polymethylmethacrylate-based resin layer as the surface layer.

In the above embodiment, the transparent plastic sheet may have a flexural modulus of 1.6 to 2.3 GPa based on ASTM D790.

Furthermore, the transparent plastic sheet may have a warpage of 0.0 to 0.5 mm when allowed to stand at a temperature of 85° C. and a relative humidity of 85% for 72 hr.

### Advantageous Effects

According to the present invention, a transparent plastic sheet can be minimally deformed under high-temperature and high-humidity conditions, and can be provided as a cover sheet for the protection of the front surface of various display products, in lieu of glass.

### DESCRIPTION OF DRAWINGS

FIG. 1 is a cross-sectional view showing a transparent plastic sheet, wherein a support layer has a monolayer structure comprising a polycarbonate-based resin layer (hereinafter, referred to as a “PC layer”); and

FIG. 2 is a cross-sectional view showing a transparent plastic sheet, wherein a support layer has a multilayer structure comprising two PC layers and a polymethylmethacrylate-based resin layer (hereinafter, referred to as a “PMMA layer”) disposed therebetween.

### BEST MODE

An aspect of the present invention addresses a transparent plastic sheet, including a support layer composed of a polycarbonate-based resin layer, and a surface layer formed on the support layer and composed of a polymethylmethacrylate-based resin layer having a glass transition temperature of 120 to 135° C., wherein the polymethylmethacrylate-based resin layer has a thickness corresponding to 5 to 20% of the total thickness of the sheet. As used herein, the term “transparent” means that light transmittance is 89% or more based on ASTM D1003. According to a preferred aspect of the present invention, the plastic sheet may be a transparent plastic sheet having a transmittance of 89 to 94%.

In the foregoing and following description, the glass transition temperature is a value measured through DMA (Dynamic Mechanical Analysis), and is specifically defined as a temperature at which the maximum value of the loss modulus (E″), measured by DMA, is exhibited. This value has a smaller error range than that of the temperature value measured through typical static differential scanning calorimetry (DSC), and is thus regarded as very precise.

In the present invention, the PC layer includes a polycarbonate-based resin. Here, the polycarbonate-based resin may include, for example, an aromatic dihydroxy compound alone, or may be obtained through interfacial polymerization of an aromatic dihydroxy compound and small amounts of a polyhydroxy compound and phosgene, or may be a linear or branched polycarbonate-based resin resulting from transesterification of an aromatic dihydroxy compound and carbonic acid diester.

The weight average molecular weight of the polycarbonate-based resin is not limited so long as a sheet may be manufactured through typical extrusion molding, but preferably falls in the range of 10,000 to 200,000, and more preferably 40,000 to 80,000. Furthermore, the polycarbonate-based resin may have a glass transition temperature of 140 to 150° C. and a refractive index of 1.55 to 1.60. The polycarbonate-based resin may include a variety of additives which are typically useful, and examples of the additives may include, but are not limited to, an antioxidant, a coloring inhibitor, a UV absorbent, a light diffuser, a flame retardant, a release agent, a lubricant, an antistatic agent, a dyeing pigment, etc.

Meanwhile, in order to provide a transparent plastic sheet that may be minimally deformed under high-temperature and high-humidity conditions according to the present invention, the glass transition temperature of the PMMA layer is controlled.

When the glass transition temperature is elevated, thermal properties may be prevented from deteriorating due to water, thereby reducing the extent of deformation under high-temperature and high-humidity conditions.

In order to elevate the glass transition temperature of the PMMA layer, heat resistance may be increased by forming a crosslinked structure in a polymer chain, and the methods thereof are not limited. By controlling the degree of crosslinking in the polymer chain, the glass transition temperature may be adjusted to a desired level.

In a preferable embodiment, the PMMA layer of the present invention has a glass transition temperature of 120 to 135° C. In the present invention, the polymethylmethacrylate-based resin (hereinafter, referred to as a “PMMA resin”) having the above glass transition temperature may be exemplified by a copolymer prepared from a resin composition comprising a styrene-based monomer, methyl methacrylate and maleic anhydride, and may be specifically obtained by polymerizing 15 to 70 wt % of styrene, 25 to 80 wt % of methyl methacrylate and 5 to 50 wt % of maleic anhydride.

The PMMA resin layer thus obtained exhibits a glass transition temperature much higher than 100 to 110° C., which is the glass transition temperature of a typical PMMA resin, for example, a methyl methacrylate homopolymer.

In the transparent plastic sheet according to the present invention, if the glass transition temperature of the PMMA layer as the surface layer is lower than 120° C., the layer is significantly affected by water, and thus a difference in deformation of individual layers may increase, undesirably remarkably decreasing the reliability of the final sheet.

When the PMMA layer having the above glass transition temperature is provided, the resulting transparent plastic sheet may have a water absorption of 0.15 to 0.2% at a temperature of 35° C. and a relative humidity of 97% and a dimensional change of 0.2 to 0.25% at a temperature of 65° C. and a relative humidity of 90%.

Such a PMMA layer may be included as the surface layer, and the thickness thereof preferably corresponds to 5 to 20% of the total thickness of the sheet. If the thickness of the PMMA layer as the surface layer is less than 5% of the total thickness of the sheet, hardness may decrease, which is undesirable. On the other hand, if the thickness thereof exceeds 20% of the total thickness of the sheet, a dimensional change may increase, which is undesirable.

Meanwhile, such a PMMA layer having high glass transition temperature, which is provided as the surface layer, may also be included even in the support layer comprising the PC layer. The configuration of the transparent plastic sheet is described below.

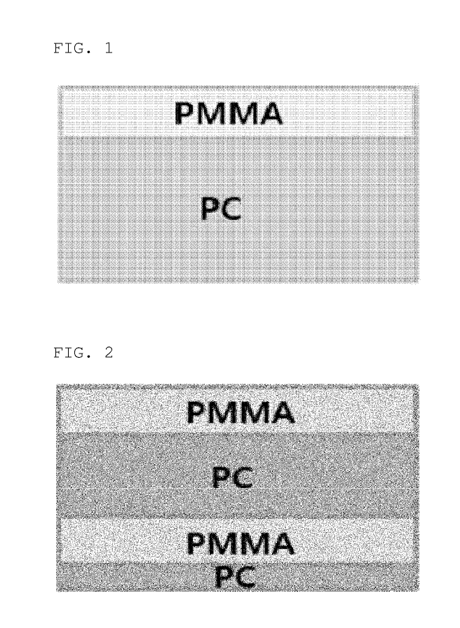

The support layer may have a monolayer structure comprising a PC layer as shown in FIG. 1, or may have a multilayer structure comprising two PC layers and a PMMA layer having a glass transition temperature of 120 to 135° C. between the two PC layers, as shown in FIG. 2.

In the latter case, when the support layer has a three-layer structure comprising two PC layers and a PMMA layer interposed between the two PC layers, the structure of the sheet is symmetrical, whereby deformation such as warping and distortion may be minimized compared to the support layer having a monolayer structure composed exclusively of the PC layer. However, the formation of a sheet having four or more layers is difficult and the relative amount of the PC may decrease, thus lowering impact strength and decreasing the improvement in reliability. Hence, the sheet is preferably composed of a maximum of four layers.

When the support layer further includes the PMMA layer, such a PMMA layer is preferably composed of a PMMA resin having a glass transition temperature of 120 to 135° C., as in the surface layer. If a PMMA resin having a glass transition temperature lower than the above range is used, it is greatly affected by water, thereby increasing the difference in deformation of individual layers, ultimately decreasing the reliability of the final sheet. Here, when the thickness of the PMMA layer included in the support layer corresponds to 5 to 20% of the total thickness of the sheet, optimal hardness and reliability may result. To stably improve impact strength, the formation of the PC layer at the bottom, which is the lowermost position of the sheet, is preferable.

In a preferred aspect of the present invention, the transparent plastic sheet includes a PMMA layer having a high glass transition temperature as the surface layer, thus satisfying a pencil hardness of H to 2H based on ASTM D3363, which is the surface hardness of the surface layer.

Also, the transparent plastic sheet may satisfy a flexural modulus of 1.6 to 2.3 GPa based on ASTM D790.

A PC resin typically has a surface hardness of B to 2B and a flexural modulus of 1 to 1.6. However, when the surface layer includes the PMMA resin layer having a high glass transition temperature, the surface hardness and flexural modulus may be increased to H to 2H and 1.6 to 2.3, respectively.

In particular, according to a preferred aspect of the present invention, the transparent plastic sheet may have a warpage of 0.0 to 0.5 mm when allowed to stand at a temperature of 85° C. and a relative humidity of 85% for 72 hr. The above warpage of the transparent plastic sheet according to the present invention is considered meaningful, taking into consideration the application thereof to a sheet for protecting the front surface of a display, that is, a window cover.

In the case of a typical window cover sheet having a PMMA layer as a surface layer, the warpage is 1 mm or more under the same conditions, and thus the likelihood of causing deformation and defects of the device is very high, but the transparent plastic sheet according to the present invention changes little even when exposed to high-temperature and high-humidity conditions including a temperature of 85° C. and a relative humidity of 85%, thus increasing the reliability of the final product.

Moreover, in the transparent plastic sheet of the present invention, a hard coating layer, which is cured through thermosetting or using active energy rays in order to improve scratch resistance, may be further formed on the surface layer. The resin used to form the hard coating layer may be properly selected from among commercially available hard coating materials, taking into account the appropriateness with the coating line, and as necessary, in addition to an organic solvent, various stabilizers such as a UV absorbent, a light stabilizer, and an antioxidant, and surfactants such as a leveling agent, a defoaming agent, a thickener, an antistatic agent, and an anti-fogging agent may be added as appropriate.

Meanwhile, the transparent plastic sheet having a multilayer structure, comprising the support layer including the PC layer and the PMMA layer formed as the surface layer thereon, may be manufactured through co-extrusion. An extruder for co-extrusion includes a main extruder for extruding the support layer and a sub extruder for extruding the surface layer, and the sub extruder is preferably smaller than the main extruder. The temperature of the main extruder ranges from 230 to 290° C. and preferably from 240 to 280° C., and the temperature of the sub extruder ranges from 220 to 270° C., and preferably 230 to 260° C. To remove impurities from the resin, a polymer filter is preferably disposed upstream of extruder dies, but the present invention is not limited thereto.

The added resins may be stacked through the known process, such as a multi-manifold process, in which different resins are provided in the form of a sheet in dies, or a feed-block process, in which respective resins are introduced into sheet dies such as T dies to form a sheet. Here, the temperature of the die ranges from 250 to 320° C., and preferably 270 to 300° C., and the temperature of the molding roll generally ranges from 100 to 190° C., and preferably 110 to 180° C., but the process is not limited so long as it is a typical co-extrusion process.

The speeds of the main extruder and the sub extruder are controlled to thus adjust the thickness of each layer. In a preferred aspect of the present invention, as mentioned above, the surface layer comprising the PMMA layer has a thickness corresponding to 5 to 20% of the total thickness of the sheet. Likewise, the thickness of the PMMA layer included in the support layer may also be controlled to 5 to 20% of the total thickness of the sheet.

### Mode for Invention

### EXAMPLES

A better understanding of the present invention may be obtained through the following examples, which are set forth to illustrate, but are not to be construed as limiting the scope of the present invention.

### Example 1

A PC resin (LC Chemicals) having a glass transition temperature of 147° C. and a PMMA resin (a terpolymer PMMA resin, 15 to 70% of styrene, 25 to 80% of methyl methacrylate and 5 to 50% of maleic anhydride) having a glass transition temperature of 129° C. were prepared. Also, an extruder for forming a support layer had a barrel diameter of 150 mm, a screw of L/D=35, and a cylinder temperature of 270° C., and an extruder for forming a surface layer had a barrel diameter of 45 mm, a screw of L/D=35, and a cylinder temperature of 245° C. Subsequently, the PC resin was introduced into the extruder for forming a support layer, and the PMMA resin was fed into the extruder for forming a surface layer, and two kinds of resins were simultaneously melt-extruded.

The inner temperatures of die pads were set to 270 and 245° C., and the stacked and integrated resins in the dies were guided to pass through three polishing rolls that were mirror-finished and disposed in a horizontal orientation. Here, the temperature was set to 100° C. for the first roll, 130° C. for the second roll, and 120° C. for the third roll, and the numbers of revolutions of the main extruder (for forming a support layer) and the sub extruder (for forming a surface layer) were determined so that the extrusion rates were set to the range of main/sub=85/15, thus manufacturing a transparent plastic sheet (thickness of 1 mm) including a surface layer having a thickness of 0.15 mm.

### Examples 2 and 3

The transparent plastic sheets of Examples 2 and 3 were manufactured in the same manner as in Example 1, with the exception that a terpolymer PMMA resin having a glass transition temperature of 120° C. and a terpolymer PMMA resin having a glass transition temperature of 130° C. were used, respectively.

### Example 4

Co-extrusion was performed in the same manner as in Example 1, with the exception that, as extruders for forming a support layer, a first extruder (having a barrel diameter of 150 mm, a screw of L/D=35, and a cylinder temperature of 270° C.), a second extruder (having a barrel diameter of 45 mm, a screw of L/D=35, and a cylinder temperature of 245° C.) and a third extruder (having a barrel diameter of 45 mm, a screw of L/D=35, and a cylinder temperature of 245° C.) were provided, and a PC resin, a terpolymer PMMA resin, and a PC resin were sequentially fed into the extruders to form a support layer. The extrusion rates of the first extruder, the second extruder, the third extruder and the sub extruder were set to the weight ratio of 70:15:15, and thus a transparent plastic sheet (thickness of 1 mm) was manufactured so that the surface layer was 0.15 mm thick, and the first support layer (PC, bottom layer), the second support layer (PMMA, middle layer), and the third support layer (PC, boundary layer) had thicknesses of 0.1 mm, 0.15 mm, and 0.6 mm, respectively.

### Comparative Examples 1 and 2

The transparent plastic sheets of Comparative Examples 1 and 2 were manufactured in the same manner as in Example 1, with the exception that a terpolymer PMMA resin having a glass transition temperature of 115° C. and a terpolymer PMMA resin having a glass transition temperature of 140° C. were used, respectively.

### Comparative Example 3

A transparent plastic sheet was manufactured in the same manner as in Example 1, with the exception that a typical PMMA (MMA polymer) having a glass transition temperature of 110° C. was used as the resin for forming a surface layer.

### Comparative Examples 4 and 5

The transparent plastic sheets of Comparative Examples 4 and 5 were manufactured in the same manner as in Example 1, with the exception that respective surface layers had a thickness of 0.03 mm, corresponding to 3% of the total thickness of the sheet, and a thickness of 0.25 mm, corresponding to 25% of the total thickness of the sheet.

The properties of the sheets of Examples 1 to 4 and Comparative Examples 1 to 5 were evaluated as follows. The results were classified into results depending on the glass transition temperature of the surface layer, results depending on the sheet configuration, and results depending on the thickness of the surface layer, and are shown in Tables 1 to 3 below.

Measurement

1) Measurement of haze and transmittance:

According to ASTM D1003, haze and transmittance were measured.

2) Measurement of flexural modulus: According to ASTM D790, a 3-point bending test was performed.

3) Measurement of surface hardness (pencil hardness): According to ASTM D3363, surface hardness was measured under an electric-type load of 1 kg using a pencil made by Mitsubishi (Mitsubishi 6B to 9H).

4) Measurement of warpage (curl): 16 Samples each having a size of 65×135 (mm) were prepared, and the degree of warpage of edges thereof was measured before testing using a steel ruler or a gap gauge. Subsequently, the samples were allowed to stand at a temperature of 85° C. and a humidity of 85% for 72 hr, tested for reliability, allowed to stand at room temperature for 30 min, and again tested for reliability, followed by measurement of the degree of warpage. The maximum values among the measured warpage values before and after the testing were selected, and the difference thereof was applied as the final warpage.

5) Water absorption: A sample having a size of 10 mm*10 mm was prepared and allowed to stand under conditions of 35° C./97% for 24 hr, followed by measuring the water absorption thereof.

6) Dimensional change: A sample having a size of 10 mm*10 mm was prepared and allowed to stand under conditions of 60° C./90% for 24 hr, followed by measuring the dimensional change thereof.

TABLE 1

| | | | | | C. |
|---|---|---|---|---|---|
| | Ex. 1 | Ex. 2 | Ex. 3 | C. Ex. 1 | Ex. 2 |
| Surface layer Tg (° C.) | 129 | 120 | 130 | 115 | 140 |
| Haze (%) | 0.06 | 0.05 | 0.07 | 0.04 | 0.19 |
| Transmittance (%) | 93.14 | 93.17 | 92.98 | 93.18 | 92.07 |
| Flexural modulus (GPa) | 2.09 | 2.07 | 2.07 | 2.07 | 2.07 |
| Surface hardness | 2H | 2H | H | 2H | HB |
| (pencil hardness) | | | | | |
| ΔWarpage (mm) | 0.22 | 0.37 | 0.29 | 0.67 | 0.21 |
| Water absorption (%) | 0.18 | 0.31 | 0.17 | 0.40 | 0.16 |
| Dimensional change (%) | 0.21 | 0.25 | 0.20 | 0.30 | 0.20 |

As is apparent from the results of Table 1, in Examples 1 to 3, in which the glass transition temperature of the surface layer (PMMA layer) ranged from 120° C. to 135° C., superior curling properties were exhibited compared to Comparative Example 1 using the PMMA layer having a glass transition temperature of less than 120° C., and excellent surface hardness was obtained compared to Comparative Example 2 in which the glass transition temperature exceeded 135° C.

TABLE 2

| | Ex. 1 | Ex. 4 | C. Ex. 3 |
|---|---|---|---|
| Surface layer | 129° C. | 129° C. | 110° C. |
| (PMMA layer) Tg | | | (typical PMMA) |
| Support layer | PC | PC + | PC |
| | | PMMA + PC | |
| Haze (%) | 0.06 | 0.06 | 0.05 |
| Transmittance (%) | 93.14 | 93.17 | 93.15 |
| Flexural modulus (GPa) | 2.09 | 2.18 | 2.07 |
| Surface hardness | 2H | 2H | 2H |
| (pencil hardness) | | | |
| ΔWarpage (mm) | 0.22 | 0.17 | 1.04 |
| Water absorption (%) | 0.18 | 0.17 | 0.44 |
| Dimensional change (%) | 0.21 | 0.20 | 0.40 |

As is apparent from Table 2, in Examples 1 and 4, in which the PMMA resin layer having a high glass transition temperature of 120° C. or more was used as the surface layer, haze, transmittance, and flexural modulus were not significantly different from those of Comparative Example 3 using a general structure including PC and typical PMMA, but surface hardness and ball impact strength were remarkably increased. In particular, changes in warpage of the sheets of the Examples were low even after exposure to high-temperature and high-humidity conditions, and these sheets were thus found to be highly reliable, and such results were improved more in the four-layer structure than in the two-layer structure.

TABLE 3

| | Ex. 1 | C. Ex. 4 | C. Ex. 5 |
|---|---|---|---|
| Surface layer thickness proportion | 15% | 3% | 25% |
| Haze (%) | 0.06 | 0.1 | 0.05 |
| Transmittance (%) | 93.14 | 92.02 | 93.15 |
| Flexural modulus (GPa) | 2.09 | 1.75 | 2.26 |
| Surface hardness (pencil hardness) | 2H | HB | 2H |
| ΔWarpage (mm) | 0.22 | 0.23 | 0.56 |
| Water absorption (%) | 0.18 | 0.28 | 0.35 |
| Dimensional change (%) | 0.21 | 0.25 | 0.28 |

Also, the properties of the sheets depending on the thickness of the surface layer are shown in Table 3. When the proportion of the PMMA layer serving as the surface layer was less than 5% of the total thickness of the sheet (Comparative Example 4), pencil hardness decreased and thus surface scratching was expected to occur. On the other hand, when the proportion thereof exceeded 20% (Comparative Example 5), warpage increased, and thus deformation minimization under high-temperature and high-humidity conditions did not reach expectations.

1. A transparent plastic sheet, comprising:
a support layer, including a polycarbonate-based resin layer, and a surface layer, formed on the support layer and composed of a polymethylmethacrylate-based resin layer having a glass transition temperature of 120 to 135° C.,
wherein the polymethylmethacrylate-based resin layer has a thickness corresponding to 5 to 20% of a total thickness of the sheet, and
the sheet has a total transmittance of 89 to 94% based on ASTM D1003.

2. The transparent plastic sheet of claim 1, wherein the support layer has a monolayer structure comprising a polycarbonate-based resin layer; or a multilayer structure comprising two polycarbonate-based resin layers and a polymethylmethacrylate-based resin layer having a glass transition temperature of 120 to 135° C. disposed between the two polycarbonate-based resin layers, and
the polymethylmethacrylate-based resin layer disposed between the two polycarbonate-based resin layers has a thickness corresponding to 5 to 20% of a total thickness of the sheet.

3. The transparent plastic sheet of claim 1, wherein the transparent plastic sheet has a water absorption of 0.15 to 0.2% at a temperature of 35° C. and a relative humidity of 97% and a dimensional change of 0.2 to 0.25% at a temperature of 65° C. and a relative humidity of 90%.

4. The transparent plastic sheet of claim 1, wherein the transparent plastic sheet has a pencil hardness of H to 2H based on ASTM D3363, which is a surface hardness of a surface of the polymethylmethacrylate-based resin layer as the surface layer.

5. The transparent plastic sheet of claim 1, wherein the transparent plastic sheet has a flexural modulus of 1.6 to 2.3 GPa based on ASTM D790.

6. The transparent plastic sheet of claim 1, wherein the transparent plastic sheet has a warpage of 0.0 to 0.5 mm when allowed to stand at a temperature of 85° C. and a relative humidity of 85% for 72 hr.

7. The transparent plastic sheet of claim 2, wherein the transparent plastic sheet has a water absorption of 0.15 to 0.2% at a temperature of 35° C. and a relative humidity of 97% and a dimensional change of 0.2 to 0.25% at a temperature of 65° C. and a relative humidity of 90%.
